(19) United States
(12) Patent Application Publication
(10) Pub. No.: US 2003/0040552 A1
(43) Pub. Date: Feb. 27, 2003

(54) Adherent microcapsules

(75) Inventors: Douglas Quong, London (CA); Kent E. Nielsen, Dorchester (CA)

Correspondence Address: Attention: Lucy C. Weiss, Office of Intellectual Property Counsel, 3M Innovative Properties Company, P.O. Box 33427, St. Paul, MN, 55133-3427, US

(73) Assignee: 3M Innovative Properties Company

(21) Appl. No.: 10/196,002

(22) Filed: Jul. 16, 2002

Related U.S. Application Data
(60) Provisional application No. 60/306,949, filed on Jul. 20, 2001.

(51) Int. Cl. C08K 9/00; C08K 9/10; C08K 3/00

(52) U.S. Cl. 523/208; 523/210; 523/122

(57) ABSTRACT

Microcapsule/adhesive compositions are provided having a solids content of greater than about 40 percent. These compositions may be subsequently diluted for application to a substrate, or alternatively may be applied in undiluted form at low application rates. The compositions are economical to use, and provide surprisingly high adhesion to substrates.

### STATEMENT OF PRIORITY

This application claims the priority of U.S. Provisional Application No. 60/306,949 filed Jul. 20, 2001, the contents of which are hereby incorporated by reference.

### FIELD

The present invention relates to processes for producing adherent compositions comprising microcapsules containing active agents, and to compositions produced thereby.

### BACKGROUND

Microencapsulation is a well-known technique for the controlled delivery of chemicals in a multitude of applications, including agricultural. Polyurea, polyamide, or polyurea-polyamide are commonly used polymer shell membranes for pesticide and pheromone encapsulation and are the subject of many patents and literature articles. For example, U.S. Pat. No. 3,577,515 to Vandegaer describes an interfacial method for the encapsulation of pesticides. Literature reports describe the process for the encapsulation of pheromones for use to disrupt the mating of the redbanded leafroller (Carde et al, 1975) and the gypsy moth (Beroza et al, 1973). The encapsulation of pheromones by an interfacial method employing polyurea as the shell is described in U.S. Pat. No. 4,487,759 to Nesbitt et al.

Insect pests cause significant economic loss to agricultural crops worldwide. For example, Lepidoptera pests cause serious crop damage primarily during the larval stage in their life cycle; the role of the adult moth is primarily reproductive. To further this reproductive end, female moths release low levels of pheromone, a chemical specific to that species, to attract a male for mating. An application of these pheromones to crops can interfere with this female to male communication, thereby disrupting mating, reducing the numbers of larva of the next mating cycle and lessening or preventing crop damage.

Since a mating cycle of a typical insect pest may last 4-6 weeks, an ability to persistently retain the pheromones on the intended substrate is required for effective control of the pests. For these pheromones or active agents to be effective, the microcapsules need to adhere to the intended substrates long enough for the active agents to diffuse or otherwise migrate out of the microcapsule. Conventional microcapsules typically do not have adhesives that provide effective adherence to the intended substrates such as plant foliage, tree barks, and the like. As an example, insect pheromone microcapsules applied to substrates such as plant foliage, may fall off or be easily washed off before most of the pheromones migrate or diffuse out of the shells.

U.S. Pat. No. 5,750,467 discloses the use of lignin to protect pest control agents from environmental degradation, wherein the pest control agent is mixed with solubilized lignin, together with a multivalent salt, and dried to form a dispersible formulation, optionally by spray-drying to form particles. No additional adhesive is added to the spray dried lignin particles.

U.S. Pat. No. 5,906,961 discloses alkanolamide spreader-sticker surfactant combinations that are mixed with pesticides to provide a composition that both increases the area of a droplet on the target and also assists the spray deposit to adhere or stick to the target. The pesticide that is added to this composition is not disclosed to be encapsulated.

Efforts to improve and/or enhance the adherence of microcapsules to plant foliage have involved combining an aqueous composition of microcapsules with a solution or suspension of adhesive prior to application. A comparison of various stickers in adhering microcapsules to leaf surfaces was described in an article entitled “A Comparison of Sticker Performance against Rain Washing of Microcapsules on Leaf Surfaces,” by Philips and Gillham in Pestic. Sci. 1973, 4, 51-57. In this article, various emulsions of sticker solutions were diluted with distilled water to give a spray solution, with subsequent suspension of microcapsules in the spray solution. This composition was then applied to leaf surfaces for evaluation. Likewise, U.S. Pat. No. 4,436,719 to Lindaberry describes a system wherein microcapsules obtained by interfacial polycondensation are blended in an adhesive suspension or solution without the prior drying out of the microcapsules. Thus, gelatin type B is stated to improve the persistent adherence of microcapsules as described therein to foliage. The preparation of the Lindaberry system is described at column 3, lines 44-50 as first suspending the microcapsules in an aqueous medium, and then adding type B gelatin to that suspension. U.S. Pat. No. 6,080,418 (Sengupta, et al) discloses a composition useful for adhering microencapsulated material to an intended substrate comprising two suspensions of microcapsules, one containing encapsulated active agents and the other containing adhesive microspheres. U.S. Pat. No. 6,063,392 (Kloczko, et al) discloses a method of first applying a layer of pressure sensitive adhesive to the intended substrate before spraying the active ingredients.

However, we recognize that there is a need for improved adherence of the active agent-containing microcapsules in the intended environment.

### SUMMARY OF THE INVENTION

It has been discovered that compositions comprising microcapsules with an adhesive composition exhibit significantly higher adherence to desired substrates if that composition has first been held as a microcapsules/adhesive concentrate composition, meaning that it has had a solid concentration of greater than about 40%, prior to dilution to an application sprayable form. The present invention thus also provides microcapsules/adhesive concentrate compositions having solids content greater than about 40%. These compositions are highly useful as intermediate forms to the final product that is applied to the target application area, and also as compositions to be applied to target application areas without dilution. These microcapsule/adhesive concentrate compositions are particularly advantageous, because these compositions are stable and easy to ship, thereby providing a highly economical and transportable composition for purchase by growers or treatment companies. Surprisingly, it has also been found that providing the microcapsule/adhesive composition in concentrated form not only enhances the economics of transportation of the product, but also significantly improves the sticking performance of the final product as applied.

In a preferred aspect of the present invention, the microcapsules/adhesive concentrate composition is provided by using a “dry blending” process, wherein substantially free-flowing microcapsules are combined with an adhesive composition such that the resulting composition has a solids content greater than about 40%, without the need to perform a separate concentration step after combining the microcapsules with the adhesive composition. In the context of the present invention, a separate concentration step would be considered filtration, evaporation, distillation, or any like physical step undertaken to separate the non-solids components from the solids components of the composition. As used in the present invention, “substantially free-flowing” refers to microcapsules that have no more than about 30% by weight of the total microcapsule composition in the form of liquid outside the microcapsule.

In an alternative aspect of the present invention, the microcapsule/adhesive concentrate composition is provided by using a wet blending process, wherein an adhesive composition and a microcapsule composition are mixed to form a microcapsule/adhesive composition, which is subsequently concentrated by removing non-solids components from the microcapsule/adhesive composition in an amount sufficient to form a microcapsule/adhesive concentrate composition-having a solids content of at least about 40%.

In another aspect of the present invention, a method for adhesively applying active agent-containing microcapsules to a substrate is provided by first providing a microcapsule/adhesive concentrate composition as discussed above, which is then diluted to a level appropriate for application at the desired location. Because the composition is provided in concentrate form with subsequent dilution, preferably by water at the site of spraying, transportation costs of this concentrate composition product are low. Surprisingly, it has also been found that providing the microcapsule/adhesive composition in concentrated form not only enhances the economics of the transportation of the product, but also significantly improves the sticking performance of the product.

In another aspect of the present invention, a method for adhesively applying active agent-containing microcapsules to a substrate at a low application concentration is provided by first providing a microcapsule/adhesive concentrate composition as discussed above, and applying said concentrate composition without subsequent dilution at an application rate of less than about 4 liters per acre. Surprisingly, the application of active agent from a microcapsule/adhesive concentrate composition at a low application rate provides effective delivery of active material, with enhanced efficiency and substantial savings of energy.

### DESCRIPTION OF THE PREFERRED EMBODIMENTS

The microcapsule/adhesive concentrate composition of the present invention has a solids content of at least about 40%, and more preferably from about 50% to about 90%, and most preferably from about 60% to about 80%. In the case of microcapsule/adhesive concentrate compositions that are to be further diluted in the field prior to application, the concentrate composition preferably comprises from about 1% to about 70%, more preferably from about 5% to about 50% and most preferably from about 20% to about 50% by weight microcapsules containing at least one active agent and from about 15% to about 90%, more preferably from about 20% to about 80%, and most preferably from about 30% to about 60% by weight adhesive polymer. In the case of microcapsule/adhesive concentrate compositions that are to be applied in the field without dilution and at a low application rate, the concentrate composition preferably comprises from about 0.5% to about 20% by weight microcapsules containing at least one active agent and from about 40% to about 75%, and more preferably from about 50% to about 70% by weight adhesive polymer. Thus, the preferred range of microcapsule content in concentrate compositions that are to be applied in an undiluted form is somewhat lower than that for concentrate compositions that are to be subsequently diluted. This preferred range is, in either case, selected to assure that the ultimate application rate of the composition is appropriate for the performance of the product in the field.

When the microcapsule/adhesive concentrate composition is diluted in preparation for application to the substrate, the concentration is reduced to a level appropriate to deliver the amount of intended active to the substrate in accordance with the application technology to be used. Preferably, the application technique to be used is spraying. In such application techniques, and in particular when using certain application equipment, a highly diluted composition is desired to assure uniform application, and further to assure that only the amount of active necessary is delivered to the substrate. Other application techniques, such as hand application using a brush, may optionally allow higher concentrations of the microcapsule/adhesive application composition. It is contemplated that highly diluted compositions are preferred in the microcapsule/adhesive application composition when using conventional application techniques. Preferably, the microcapsule/adhesive application composition has a concentration of less than about 2% by weight of adhesive, more preferably less than about 1%, and most preferably less than about 0.5% by weight in the microcapsule/adhesive application composition.

In a preferred aspect of the present invention, substantially free-flowing microcapsules are combined with a high solids adhesive composition without first creating a solution or suspension of the microcapsules. This embodiment provides a number of benefits in the present invention. Because both the microcapsules and the adhesive are provided as high solids compositions, there is no need to undertake concentration steps to remove non-solids components from the microcapsule/adhesive concentrate composition. Because such concentration steps are not carried out in this embodiment, there is no release of potentially polluting solvents into the atmosphere as a result of the formation of the microcapsule/adhesive concentrate composition, or alternatively no requirement to remove potentially contaminated water from the composition. In addition to the benefit of reducing waste, there is also benefit of not having to exert the energy required to remove such excess components from the composition. While not being bound by theory, it is believed that providing the microcapsules in a free-flowing state provides better contact of the adhesive to the microcapsules, thereby enhancing adhesion of the microcapsule to the substrate as compared even to microcapsules that are initially mixed with adhesive in a wet state and concentrated to the desired solids content as discussed below. As stated above, a substantially free-flowing microcapsule composition has no more than about 30% by weight of the total microcapsule composition being in the form of liquid outside of the microcapsule. More preferably, the substantially free-flowing microcapsule composition has no more than about 25%, and more preferably no more than about 15% by weight of the total microcapsule composition being in the form of liquid outside of the microcapsule. Most preferably, the substantially free-flowing microcapsule composition has no more than about 10%, and more preferably no more than about 5%, and most preferably no more than about 2% by weight of the total microcapsule composition being in the form of liquid or moisture outside of the microcapsule.

In another aspect of the present invention, microcapsules are combined with adhesive composition, with subsequent removal of non-solids components, such as solvent or aqueous diluent, such that the microcapsule/adhesive composition has a solids content of at least about 40%. Because the microcapsule/adhesive composition has at some stage been at a high solids content, the resulting diluted composition exhibits significantly higher adherence of microcapsules to the desired substrates after spraying. Without being bound by theory, it is believed that the exposure of the microcapsules to an adhesive in a high solids context provides superior association of the adhesive to the microcapsule, thereby improving adhesion performance of the microcapsule to the desired substrate even after dilution of the microcapsule/adhesive concentrate composition to form the microcapsule/adhesive application composition. This embodiment is less preferred than the previously described embodiment wherein the microcapsules and adhesive compositions are combined while initially containing as small amount of solvent or diluent as possible, because the removal of solvent or diluent may require energy, and may also raise issues of release of volatile organic compounds into the atmosphere in the case where the diluent is an organic solvent.

Preferred microcapsules used in accordance with the present invention have a shell wall and a filled center containing an active agent. The microcapsule of the present invention is filled with the preselected active agent, and an optional carrier or solvent. The fill is the substance encapsulated in the microcapsule. Depending on the release profile intended, the fill may be made with different chemistries (fill chemistry). The fill may be solid, liquid or gaseous depending on the need or area of intended application. The “fill chemistry” as used in the present invention relates to the combination of the active agent and the optional carrier inside the shell. If a carrier is not required, the fill chemistry comprises the active agent required for a particular insect pest or intended environment. Where it is necessary to employ a carrier, the fill chemistry includes such carriers and active agents as needed to accomplish the desired insect pest control. Suitable material usable for carriers include xylene, toluene, alkyl naphthalene, aromatic, aliphatic and isoparaffinic hydrocarbons, tetrahydronaphthalene, kerosene, amyl alcohol, ethyl amyl ketone, oxitol acetate, amyl acetate, cyclohexanone, dibutyl phthalate, dioctyl phthalate, and the like as discussed in U.S. Pat. No. 4,681,806 to Matkan, et al., and U.S. Pat. No. 3,516,941 to Matson.

The shell wall of the microcapsules can be prepared using a variety of encapsulation techniques. Preferably, the shell wall of the microcapsules is selected in material and geometry to achieve a desired rate of activity when the microcapsules are introduced to their intended environment. This rate of activity is related to release profile, and is affected by environmental reactivity, porosity of the shell wall, and the like. The shell wall may be made from any material suitable for retention and delivery of the desired active agent. Preferred such shell walls are made from polymers such as polyurea, polymethylene urea, melamine/urea, urea formaldehyde, polyamide, polyurethane, gelatin, and the like. Examples of known techniques for manufacturing microcapsules are provided in, for example, U.S. Pat. No. 6,080,418, which discloses the use of polyurea as microcapsule shell walls. United Kingdom Patent No. 1,371,179 discloses the preparation of polyurea microcapsules for several products including insecticides. Similarly, U.S. Pat. No. 4,487,759 discloses the encapsulation by interfacial polycondensation of biologically active agents in polyurea. Other encapsulation processes are disclosed in U.S. Pat. Nos. 2,800,457; 3,577,515; 4,046,741; 4,140,516; 4,417,916; 4,532,123; 4,563,212; 4,689,293; and EP 611,253.

In an embodiment of the present invention, a urea-formaldehyde microcapsule containing an active agent is made substantially free-flowing by washing and filtering after the encapsulation process.

The term “active agent” as used in the context of this invention, comprises individually biologically active ingredients, or a plurality of ingredients that act either individually or in combination as biologically active ingredients. Examples of active agents include pharmaceuticals, fungicides, herbicides and pesticides such as bactericides, acaricides and insecticides. Particularly preferred biologically active materials are the pyrethroids, mercaptans, pheromones and other such semiochemicals, whether naturally produced or artificially synthesized.

Pheromones may be defined as compounds which, when naturally produced, are secreted by one member of an animal species which can influence the behavior or development of another member of the same animal species. Pheromones are species-specific, and therefore the application of pheromones for insect behavior modification has minimal effect on non-target pests. Preferred pheromones supplied for modification of insect behavior interfere with the “mate finding process” by releasing point sources of pheromone, which may compete with or camouflage the pheromone plume of a female. Pheromones released to the intended environment, when properly constituted, may serve to disrupt the mating process of the targeted insect species. As pheromones are very species-specific and are used only in small quantities, their use is more environmentally acceptable than broadcasting of pesticides.

Pheromones useful in the invention are preferably insect pheromones. In describing the structure of the pheromone, the following notation is used: the type (E (trans) or Z(cis)) and position of the double bond or bonds are given first, the number of carbon atoms in the chain is given next and the nature of the end group is given last. To illustrate, the pheromone Z-10 C19 aldehyde has the structure;

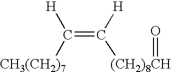

Pheromones can be mixtures of compounds with one component of the mixture predominating, or at least being a significant component. Partially water-miscible significant or predominant components of insect pheromones, with the target species in brackets, include, for example: E/Z-11 C14 aldehyde (Eastern Spruce Budworm), Z-10 C19 aldehyde (Yellow Headed Spruce Sawfly), Z-11 C14 alcohol (Oblique Banded Leafroller), Z-8 C12 alcohol (Oriental Fruit moth), E,E-8,10 C12 alcohol (Codling moth), E-11 C14 alcohol (Tufted Apple Budmoth), E-11 C14 acetate (Sparganothis Fruitworm), Z-11 C14 acetate (Blackheaded Fireworm), Z-9 C12 acetate (Grape Berry Moth), Z-11 C14 acetate (Leafroller), E/Z-4 C13 acetate (Tomato Pinworm), Z,Z/Z,E-7,11,C16 acetate (Gossyplure), Z-8,C12 acetate (Oriental Fruit Moth), Z/Z-3,13 C18 acetate (Peach Tree Borer), E,Z/Z,Z-3,13-C18 acetate (Lesser Peach Tree Borer), and 7,8-Epoxy-2-methyl C18 (Gypsy Moth), among others.

An example of a ketone that is a pheromone is E or Z-7-tetradecen-2-one, which is effective with the oriental beetle. An ether that is not a pheromone but is of value is 4-allylanisole, which can be used to render pine trees unattractive to the Southern pine beetle.

Other compounds may optionally be included in the microcapsules of the invention, including perfumes, fragrances, flavoring agents, co-attractants and the like.

Optionally, oil absorbents can be incorporated into the pheromone. These absorbents can help retain the pheromone within the microcapsules, resulting in longer lasting formulations. Clays and starches could alternatively be used for this purpose.

The concentration of pheromone of the present invention should be at a level such that the microcapsule can still provide a strong, rupture resistant network and deliver an effective amount of the pheromone to the intended environment. Thus, the pheromone is preferably present in an amount between about 0.1 wt % to about 90 wt % (weight percent) of the total weight of the microcapsule. More preferably, the amount of pheromone present in the microcapsule is between about 20 wt % to about 85 wt %; and most preferably between about 30 wt % to about 80 wt %.

The concentration of the active agents may be controlled to achieve the desired release profiles for the intended environment. In a typical embodiment, the active agents of the present invention are encapsulated in concentrations to meet a desired particular release profile as determined for a particular environment.

In some applications, it is practical or even preferable to utilize a carrier to facilitate the encapsulation of an active agent. A “carrier” as used herein refers to a component incorporated within the microcapsule usable to aid in encapsulation and/or release of the active agent. If a carrier is used, it may be solid or liquid depending on the active agent to be encapsulated. A carrier may be inert or reactive with the active agent. Typical carriers include xylene, toluene, alkyl naphthalene, kerosene, amyl alcohol, and the like, such as disclosed in U.S. Pat. Nos. 3,516,941 and 4,681,806.

The microcapsule/adhesive application compositions of the present invention are preferably sprayable. By “sprayable” is meant that the microcapsule-containing composition of the present invention can be applied to the intended environment using spraying means as are known in the art. Preferably, the microcapsules used in compositions of the present invention are frangible, but not so fragile so that they are not capable of being sprayed through conventional spray equipment. Preferably, the overall composition is not so viscous or tacky so as to clog up the nozzles of the spraying equipment. For aerial and similar spraying processes, the microcapsules should remain in the composition and not settle to the bottom or float to the top of the containers during the spraying process.

The size of the microcapsule may be used to control the amount of active agents released to an intended environment. As used herein, size refers to the average size of a class of microcapsules. Depending on the need, the size of the microcapsule can be a vehicle to deliver different quantities of desired active agents, and effective to regulate the ratio of one active agent to another. Different processes as known in the art are used to vary the shell sizes, including surfactant as described in U.S. Pat. No. 6,080,418, and agitation of the encapsulating polymeric compound. To vary the release profile, a blend of microcapsules may have a plurality of sizes wherein the first class of capsules is different from the second class, and so on. The average size of the microcapsules preferably is from about 10 to about 250 microns. More preferably, the average size of the microcapsules is from about 10 to about 100 microns.

The microencapsulated active agent of the present invention is dry blended with an adhesive composition. Typical adhesive compositions usable in the present invention include adhesives that are soft at room temperature and possess low glass transition temperatures (T_{g}); have low viscosity; have stable elastic modulus and high tan delta; and high solids percentage.

Preferably, adhesive compositions usable in the present invention are soft enough to directly coat the microcapsule during the blending process. A soft adhesive characterized by a glass transition temperature (T_{g}) within the range of −50° C. and −10° C. is preferred.

Preferably, the adhesive used in the present invention exhibits low viscosity in order to facilitate mixing of a high solids composition of the adhesive with microcapsules, and also to facilitate the ultimate mixing of the microcapsule/adhesive concentrate with the diluent in the field in order to prepare an application composition. Preferably, such adhesives have an apparent Brookfield viscosity of about 200 to 1500 mPa-s (rvt spindle no. 3 at 100 rpm, 23° C.). The viscosity of the adhesive composition is affected by the chemical nature of the polymers that form the adhesive. Thus, long chain polymers tend to form higher viscosity adhesive compositions. The viscosity of the adhesive composition may additionally be adjusted, for example, by diluting the adhesive with an appropriate solvent to lower the observed viscosity, or adding more undiluted adhesive to raise the observed viscosity.

By careful selection of the adhesive polymer and overall adhesive composition to be used in the present invention, one may select a very high solids content adhesive, which in turn provides a microcapsule/adhesive concentrate composition that is surprisingly very pourable. For example, Acronal A200 adhesive is a preferred adhesive, which has an apparent Brookfield viscosity of about 200-800 mPa-s at a 70% solids content (rvt spindle no. 3 at 100 rpm, 23° C.).

Preferred adhesives to be used in the present invention have a stable elastic modulus and high tan delta. Such adhesives have elastic modulus in the range of about 1000 to about 500,000 dynes/cm and a tan delta (tan A) greater than 0.3 within a temperature range of 30° C. and 150° C.

Exemplary adhesive compositions usable in the present invention include acrylate copolymer, and acrylate tert-polymer adhesives made from such monomers as acrylic, vinyl acetate, acrylonitrile, or styrene. Preferred adhesives are discussed in the following articles: “70% solids acrylic emulsion reduces odor in flooring adhesive” Business New Publishing Co., ASI February 1999, p. 106; and “New high-solids emulsion polymer for wide temperature PSA applications (new high-solids emulsion polymer for pressure sensitive adhesive) Adhesives & Sealants Industry, V8, N8, p. 44. Additional preferred adhesives are described in the following patent publications: WO 2001044562; U.S. Pat. No. 5,340,859; U.S. Pat. No. 5,436,289; U.S. Pat. No. 5,426,146; U.S. Pat. No. 5,498,655; EP 568,834; EP 567,819; and EP 567,811.

The microcapsule/adhesive concentrate composition is preferably prepared by first providing the adhesive composition in a vessel capable of being stirred or agitated. The microcapsule containing composition is then added to this adhesive composition. This is particularly the case where the microcapsules are added in the form of substantially free-flowing microcapsules. The microcapsule composition is preferably added to the adhesive composition gradually, and with stirring to provide a homogeneous mixture. Additional components, such as surfactants or other appropriate additives, are then added to the microcapsule/adhesive concentrate composition.

Surfactants are preferably incorporated into the microcapsule/adhesive concentrate composition to further stabilize the adhesive system contained therein, so that when the concentrate composition is further diluted (where applicable), the components of the composition will not coagulate. Particular preferred surfactants are nonionic. Examples of suitable surfactants include poly(ethoxy)nonylphenol. Poly(ethoxy)nonylphenols are commercially available under the trade designation IGEPAL from Rhone-Poulenc (Cranbury, N.J.), with various molecular weights depending on the length of the ethoxy chain. Other examples of suitable surfactants include polyether block copolymers, such as those available under the trade designations PLURONIC and TETRONIC, both available from BASF (Washington, N.J.), polyoxyethylene adducts of fatty alcohols, such as BRIJ surfactants available from ICI (Washington, Del.), and esters of fatty acids, such as stearates, oleates, modified fatty alcohol polyglycol ether available under the trade designation DISPONIL from Cognis Corporation (Cincinnati, Ohio) and the like. Examples of such fatty acids include sorbitan monostearate, sorbitan monooleate, sorbitan sesquioleate, and the like. Examples of the alcohol portions of the fatty esters include glycerol, glycosyl and the like. Fatty esters are commercially available as surfactants under the trade designation ARLACEL C from ICI (Wilmington, Del.). Preferably, the surfactant is biodegradable and environmentally friendly.

It is desirable that the microcapsules be capable of remaining suspended in the adhesive composition and not sink, settle, float or coagulate. A microcapsule/adhesive composition having a uniform distribution of microcapsules therein provides a composition that may readily be evenly sprayed over the desired substrate. It is preferred that the microcapsules remain suspended in the adhesive composition to minimize or eliminate the need to agitate the composition during application. Suspension aids may be added to keep the microcapsules from sinking to the bottom or floating to the top of the container. Such suspension aids may be added to the microcapsule/adhesive concentrate, or may separately be added at the time of dilution of the microcapsule/adhesive concentrate composition with water prior to spraying on the intended substrate. Typical suspension aids include rhamsam gum, xanthum gum, gellan gum, pectin, and gum arabic.

The microcapsule/adhesive compositions may be delivered to the intended environment using composition delivery technologies as are known in the art. As discussed above, in one embodiment of the present invention the microcapsule/adhesive concentrate composition is converted to a microcapsule/adhesive application concentration by appropriate dilution in the field, and then delivered to a substrate by spray technology. Typically, this dilution may be carried out by adding the microcapsule/adhesive concentrate composition to a large vessel containing water, with stirring or other appropriate agitation. The microcapsule/adhesive concentrate composition may be in a highly viscous format in this embodiment, provided that adequate mixing may be accomplished without undue effort and without injury to the microcapsules. In order to ease the dilution and mixing process, a preferred embodiment of the present invention provides the microcapsule/adhesive concentrate composition as a pourable composition at ambient weather conditions at the time of mixing in the field. A preferred viscosity range of the concentrate formulation in this embodiment prior to dilution is from about 100 to about 700,000 mPa-s, and more preferable from about 300 to about 400,000 mPa-s, within a shear stress from 0.05 to 50 sec⁻¹. Unless otherwise indicated, the viscosities of microcapsule/adhesive compositions, whether as concentrate compositions or application compositions, described herein are measured using an AR2000 Rheometer (TA Instruments, Delaware) with 25 mm parallel plates at 25° C.

A substrate, as used herein, refers to the surface to which the microcapsule/adhesive application composition is applied. Typical substrates include, for example plant foliage, tree barks, and the like.

A typical delivery process is by spraying the microcapsules onto the environment of interest. Spraying, and particularly aerial spraying, is highly economical because a large area may be covered in a short time.

Some spray processes utilize atomization to introduce the microcapsules onto the intended environment. In a preferred such atomization technique, the adhesive composition containing microcapsules is forced through two rotating perforated discs that are immediately upstream of the discharge nozzle. The microcapsules of the present invention are desirably sufficiently elastic to minimize physical damage to the microcapsules as they pass through the discs. The microcapsules usable for atomization may be any of the microcapsules suitable for encapsulating biologically active agents, including polyurea, polyurethane, melamine/urea, gelatin microcapsules, and the like. The microcapsules containing the biologically active agent preferably are provided in a size in the range of from 1 micron to 2 mm.

In another preferred embodiment of the present invention, the microcapsule/adhesive concentrate composition is applied in an undiluted form at an application rate of less than about 4 liters per acre, more preferably from about 0.2 to about 3 liters per acre, and most preferably from about 0.5 to about 2 liters per acre. This embodiment is particularly useful in treatment of extremely large areas of land, such as forests. Large parcels of land are preferably treated by aerial spraying. The present invention provides substantial benefit in such applications due to the superior indication of the microcapsules to the substrate of interest. Thus, when active agent is applied at a significantly low application rate as contemplated herein, the loss of any of the active agent due to washing away of the microcapsules may have a profound adverse effect on the success of the active agent treatment process. This low application rate method is particularly useful, for pheromones, which require only a small amount of chemical to be located in the environment to be effective.

Under prior art processes, the active agent is conventionally applied at a dilute concentration, even when using aircraft to cover large amounts of territory. This necessitates the accommodation of compositions comprising large quantities of water or other inactive ingredient in the aircraft. Further, when the composition is extremely dilute in content of active agent, a fast application rate is required, which thereby quickly depletes the supply of treatment composition on board the aircraft, and necessitates a greater number of refilling stops throughout the application process. In contrast, because the present composition is in a highly concentrated form relative to prior art dilute compositions, and because the present composition is applied at a lower rate from a composition quantity per unit of land standpoint, it is now possible to deliver an appropriate amount of active agent to large areas of land to be treated without the need to frequently refill the vessels on board the aircraft. A substantial savings in aircraft fuel due to the lower cargo weight required for the treatment of a given parcel of land is also realized.

Preferably, the microcapsule/adhesive concentrate composition, when directly applied without dilution as described above has a viscosity range of from about 1 to about 200,000 mPa-s, and more preferably from about 10 to about 100,000 mPa-s.

Objects and advantages of this invention are further illustrated by the following examples, but the particular materials and amounts thereof recited in these examples, as well as other conditions and details, should not be construed to unduly limit this invention. Parts and percentages are by weight unless otherwise indicated.

### EXAMPLES

Test Method

Aqueous solutions of 3M urea formaldehyde microcapsules containing the active agent E, E,-8,10 C12 alcohol (pheromone of the codling moth “codlemone”) or model compound (dodecan-1-ol) were used to model the effectiveness of different stickers for persistency after a simulated rain event.

All formulations of microcapsule-containing compositions were applied to apple foliage using a De Vries Spray Booth sprayer employing one T-Jet 8002E nozzle. The microcapsule-containing compositions were applied at a suitable dilution ranging from 1:25 to as high as 1:800 (nozzle output rate 49 liters per minute; nozzle speed 37.6 meters per minute). Apple leaves which were sprayed were then placed in the simulated rain unit and “rained on” for a period of 15 minutes at a rain intensity of about 2 cm of water per hour. The foliage was then removed and the active ingredient was extracted and quantified by gas chromatography. The percentage of active ingredient remaining was recorded (% Residual).

The solvent or other solution content of the microcapsules provided in the “substantially free-flowing” form is evaluated by thermal gravimetric analysis or Karl Fisher analysis.

### Example 1

Dry-Blended Microcapsule-Containing Dodecan-1-ol Composition

Urea formaldehyde microcapsules were prepared according to U.S. Pat. No. 3,516,941 using dodecan-1-ol, obtainable from Aldrich Chemical, as the active agent. The microcapsules were washed and filtered using a Buchner vacuum filtration unit. The wash/filtration process was repeated three (3) times to obtain substantially free-flowing microcapsules. The washed and filtered microcapsules were bottled in a jar. In a 125 mL reactor, 10 grams of microcapsules containing about 5% water was combined with about 21 grams of Acronal A200 acrylate adhesive composition, obtainable from BASF, Germany. A turbine impeller was used to mix the composition at a speed of 1000 rpm for about 30 minutes or until a homogeneous blend of the microcapsule in the adhesive composition was obtained. The final concentrate composition contained a total % solids of about 79%.

In a 500 mL bottle, a known weight of the microcapsule-containing composition was diluted in about 200 grams of tap water, depending on the intended dilution. The solution was continually mixed in the De Vries Spray Booth sprayer and sprayed into apple foliage. The sprayed apple foliage were then allowed to air dry at room temperature for 2 hours after which the leaves were exposed to simulated rain such that a total of about 0.5 cm of water was applied. The control sample had no adhesive and the formulation was diluted using tap water.

### Example 2

Dry-Blended Microcapsule-Containing Dodecan-1-ol Composition

This example was similar to that described in Example 1; however, approximately 6 grams of filtered dodecan-1-ol microcapsules containing about 5% of water was blended into 20 grams of Acronal A200 acrylate adhesive composition. The concentrate composition contained a total % solids of about 76%. For the rain study, 5 grams of concentrate was diluted in 200 grams of tap water. The residual amount of active ingredient after the rain test is tabulated in Table 1.

### Example 3

Dry-Blended Microcapsule-Containing E,E-8,10 C12 Alcohol (Codling Moth) Composition

This example was similar to that described in Example 1; however, approximately 3 grams of filtered codling moth microcapsule containing about 5% of water was blended into 20 grams of Acronal A200 acrylate adhesive composition. The concentrate composition contained a total % solids of about 73%.

### Example 4

Dry-Blended Microcapsule-Containing E,E-8,10 C12 Alcohol (Codling Moth) Composition

This example was similar to that described in Example 1; however, using the codling moth pheromone (E,E-8, 10 C12 alcohol) obtainable from Shin-Etsu (Japan), as the active agent. After the washing/filtering procedure of the microcapsules, approximately 4 grams of filtered codling moth microcapsules containing about 3% of water was blended into 50 grams of Acronal A200 acrylate adhesive composition, obtainable from BASF, Germany. The concentrate composition contained a total % solids of about 68%.

The spraying procedure was similar to that described in Example 1; however, 0.3 grams of microcapsule/adhesive from Example 4 was diluted in 200 grams of hard ground water.

### Example 5

Dry-Blended Microcapsule-Containing E,E-8,10 C12 Alcohol (Codling Moth) Composition and Surfactant

This example was similar to that described in Example 4. The codling moth pheromone was microencapsulated according to U.S. Pat. No. 3,516,941. After the washing/filtering procedure of the microcapsules, approximately 4 grams of filtered codling moth microcapsules containing about 3% of water was blended into 50 grams of Acronal A200 acrylate adhesive composition. After mixing the microcapsule/adhesive composition for about 30 minutes, 0.1 grams of Disponil 1080 surfactant was added, obtainable from Cognis Corporation (Cincinnati, Ohio). An additional 15 minutes of mixing was allowed to ensure a homogenous solution. The concentrate composition contained a total % solids of about 69%.

The spraying procedure was similar to that described in Example 1; however, 0.3 grams of microcapsule/adhesive from Example 5 was diluted in 200 grams of hard ground water.

### Example 6

Dry-Blended Microcapsule-Containing E,E-8,10 C12 Alcohol (Codling Moth) Composition and Surfactant

This example was similar to that described in Example 4; however, approximately 20 grams of filtered codling moth microcapsules containing about 15% of water was blended into 36 grams of Acronal A200 acrylate adhesive composition. After mixing of the capsule slurry, 3 grams of Disponil 1080 was added as surfactant. The concentrate composition contained a total % solids of about 71%.

The spraying procedure was similar to that described in Example 1; however, 0.3 grams of microcapsule/adhesive from Example 6 was diluted in 220 grams of hard ground water.

### Example 7(Comparative)

Wet-Blended Microcapsule-Containing Dodecan-1-ol Composition

Urea formaldehyde microcapsules were prepared according to U.S. Pat. No. 3,516,941 using dodecan-1-ol. The washed and filtered microcapsules were resuspended in xanthan gum (used as a suspending aid) solution such that its concentration was about 0.1% and the active ingredient was 10%. For the rain study, 5 grams of this concentrate was diluted in 200 grams of tap water.

The spraying procedure was similar to that described in Example 1; however, 0.3 grams of Acronal A200 was diluted into a 500 mL bottle containing 200 grams of tap water. The adhesive was dispersed into the water first followed by the addition of 5 grams of microcapsule concentrate. The suspension was then continually mixed and sprayed. The residual amount of active ingredient after the rain test is tabulated in Table 1.

TABLE 1

| | | % Residual Active |
|---|---|---|
| Example No. | Description | Ingredient |
| 2 | Dry blended microcapsules: | 29.9 |
| | Final adhesive conc. 0.12% | |
| 7 | Wet blended microcapsules: | 15.6 |
| | Final adhesive conc. 0.12% | |
| | Control (no adhesive) | 8.7 |

All publications, patents and patent documents are incorporated by reference herein, as though individually incorporated by reference. The invention has been described with reference to specific and preferred embodiments and techniques. However, other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims.

We claim:

1. A method for providing a microcapsule/adhesive application composition that exhibits high adherence of microcapsules to a surface, comprising:
a) providing a microcapsule/adhesive concentrate composition comprising:
i) microcapsules containing at least one active agent, and
ii) adhesive polymer,
wherein said microcapsule/adhesive concentrate composition has a solids content of at least about 40%; and
b) diluting said microcapsule/adhesive concentrate composition to a concentration suitable for applying to a substrate to form a microcapsule/adhesive application composition.

2. The method of claim 1, wherein the microcapsule/adhesive concentrate composition has a solids content of from about 50% to about 90%.

3. The method of claim 1, wherein the microcapsule/adhesive concentrate composition has a solids content of from about 60% to about 80%.

4. The method of claim 1, wherein the microcapsule/adhesive concentrate composition is diluted to a concentration of less than 2% by weight of adhesive in the microcapsule/adhesive application composition.

5. The method of claim 1, wherein said active agent comprises at least one pheromone.

6. A microcapsule/adhesive concentrate composition comprising:
a) microcapsules containing at least one active agent; and
b) adhesive polymer;
wherein said microcapsule/adhesive concentrate composition has a solids content greater than about 40%.

7. The microcapsule/adhesive concentrate composition of claim 6, wherein the microcapsule/adhesive concentrate composition has a solids content of from about 50% to about 90%.

8. The microcapsule/adhesive concentrate composition of claim 6, wherein the microcapsule/adhesive concentrate composition has a solids content of from about 60% to about 80%.

9. The microcapsule/adhesive concentrate composition of claim 6, wherein the microcapsule/adhesive concentrate composition comprises from about 1% to about 70% by weight microcapsules containing at least one active agent and from about 15% to about 90% by weight adhesive polymer.

10. The microcapsule/adhesive concentrate composition of claim 6, wherein said active agent comprises at least one pheromone.

11. A method of preparing a microcapsule/adhesive concentrate composition comprising:
a) providing substantially free-flowing microcapsules containing at least one active agent;
b) providing an adhesive composition; and
c) combining said substantially free-flowing microcapsules and said adhesive composition in amounts effective to form a microcapsule/adhesive concentrate composition having a solids content greater than about 40% without a separate concentration step after combining the microcapsules with the adhesive composition.

12. The method of claim 1, wherein the microcapsule/adhesive concentrate composition has a solids content of from about 55% to about 80%.

13. The method of claim 11, wherein the microcapsule/adhesive concentrate composition has a solids content of from about 65% to about 75%.

14. The method of claim 11, wherein the microcapsule/adhesive concentrate composition comprises from about 1% to about 70% by weight microcapsules containing at least one active agent and from about 15% to about 90% by weight adhesive polymer.

15. The method of claim 11, wherein said active agent comprises at least one pheromone.

16. The method of claim 11, wherein the viscosity of said microcapsule/adhesive concentrate composition is from about 1 to about 200,000 mPa-s.

17. The product made by the method of claim 11.

18. A method of preparing a microcapsule/adhesive concentrate composition comprising:
a) providing an adhesive composition;
b) providing a microcapsule composition;
c) mixing said adhesive composition and microcapsule composition to form a microcapsule/adhesive composition;
d) removing non-solids components from the microcapsule/adhesive composition in an amount sufficient to form a microcapsule/adhesive concentrate composition having a solids content of at least about 40%.

19. The method of claim 18, wherein the microcapsule/adhesive concentrate composition has a solids content of from about 55% to about 80%.

20. The method of claim 18, wherein the microcapsule/adhesive concentrate composition has a solids content of from about 65% to about 75%.

21. The method of claim 18, wherein the microcapsule/adhesive concentrate composition comprises from about 1% to about 70% by weight microcapsules containing at least one active agent and from about 15% to about 90% by weight adhesive polymer.

22. The method of claim 18, wherein said active agent comprises at least one pheromone.

23. The method of claim 18, wherein the viscosity of said microcapsule/adhesive concentrate composition is from about 1 to about 200,000 mPa-s.

24. The product made by the method of claim 18.

25. A method for adhesively applying active agent-containing microcapsules to a substrate, comprising
a) providing a microcapsule/adhesive concentrate composition of claim 6;
b) diluting said microcapsule/adhesive concentrate composition to a concentration suitable for application to a substrate, thereby forming a microcapsule/adhesive application composition; and
c) applying said microcapsule/adhesive application composition onto said substrate.

26. A method for adhesively applying active agent-containing microcapsules to a substrate, comprising
a) providing a microcapsule/adhesive concentrate composition of claim 6;
b) applying said microcapsule/adhesive concentrate composition onto said substrate at an application rate less than about 4 liters per acre.

27. The method of claim 26, wherein said microcapsule/adhesive concentrate composition is applied onto said substrate at an application rate of from about 0.2 to about 3 liters per acre.

28. The method of claim 26, wherein said microcapsule/adhesive concentrate composition is applied onto said substrate at an application rate of from about 0.5 to about 2 liters per acre.
